(19) United States
(12) Patent Application Publication
(10) Pub. No.: US 2015/0052816 A1
(43) Pub. Date: Feb. 26, 2015

(54) ROTATABLE SLIDING WINDOW

(71) Applicant: NAM LEE PRESSED METAL IND LTD., Singapore (SG)

(72) Inventors: Jee Meng Chen, Singapore (SG); Han Keong Yong, Singapore (SG); Kin Sen Yong, Singapore (SG)

(73) Assignee: NAM LEE PRESSED METAL IND LTD., Singapore (SG)

(21) Appl. No.: 14/289,455

(22) Filed: May 28, 2014

(30) Foreign Application Priority Data
Aug. 20, 2013 (SG) 201306311-0

(51) Int. Cl. E06B 3/50; E05D 15/58; E05D 15/48; E06B 5/00; E06B 7/00

(52) U.S. Cl. CPC E06B 3/5018; E06B 5/00; E06B 7/00; E05D 15/48; E05D 15/58; E05D 2015/485; E05D 2015/586
USPC 49/177

(57) ABSTRACT

The present invention relates to a window and more particularly, to a window incorporating means for effecting pivotal movement of the window panel out of the plane in which the panel is slidable so as to facilitate cleaning of both sides of the window panel. The window includes a top rail guide member 13, a rotatable panel 14, and a bottom rail guide member 15, at least one of the guide members being moveable with the window panel in a direction other than one which is slidable. The invention also includes a lifting mechanism adapted to vertically displace the rotatable panel 14 in order to disengage the complementary engaging members 27, 29 connecting the panel and bottom rail guide member together and allow the rotatable panel 14 to rotate.

### RELATED APPLICATIONS

This application claims priority to Singapore Patent Application No. 201306311-0, filed on Aug. 20, 2013. The foregoing is incorporated by reference herein.

### FIELD OF THE INVENTION

The present invention relates to a rotatable sliding window.

### BACKGROUND TO THE INVENTION

In a conventional sliding window, the cleaning of the outside surface of the window panels is difficult and can potentially be life-threatening to the cleaner, especially in high-rise flats and apartments common in densely populated Singapore. Indeed, fatalities have occurred due to falls while cleaning such windows and yet despite the risks, people continue to put their lives in danger to clean them. This may be due to the high cost of hiring professional cleaners to clean the exterior surface of windows.

As such, many attempts to minimise the risks associated with the window cleaning process have been proposed, for example, U.S. Pat. No. 5,140,769, U.S. Pat. No. 4,337,597, U.S. Pat. No. 637,502, U.S. Pat. No. 593,855 and U.S. Pat. No. 153,100 which teach the construction of sliding windows where the window panels are centrally pivoted, allowing the or each window panel to reversibly rotate about the pivot. The central location of the pivot is an advantage since it potentially allows at least 180 degrees of rotation. However, there are certain disadvantages with some of the prior art. For example, some do not include adequate weatherproofing features, or they may be difficult to operate. Moreover, some with intricate and complex track systems compound the problem caused by debris build-up.

Also, a number of prior art relate to vertical sliding reversible windows which may be more common in the past or in other countries. However, at present, wide window openings are much more common in residential buildings, therefore horizontal sliding windows would be more suitable for such applications.

Accordingly, there remains a need for an easy to operate, rotatable sliding window that allows for easy and safe cleaning of both window panel surfaces and at the same time minimises the risk of trapping debris and which incorporates simple and effective weather-proofing.

### SUMMARY OF THE INVENTION

The present invention relates to a rotatable sliding window including a window frame adapted to be fixed within an opening in a structure, having one or more window panels supported within the frame between opposed moveable supports fitted to guide members in the frame, the or each window panel being adapted for slidable movement to allow the window to be opened and closed, wherein the opposed moveable supports are linked to the or each window panel via pivot pins such that:
a) the opposed moveable supports are able to slide with the or each window panel; and
b) the or each window panel is able to move relative to the opposed moveable supports and rotate about the axis of the pivot pins to move out of the sliding plane to allow access to both sides of the or each window panel;
   wherein one of the opposed moveable supports associated with a window panel and the window panel associated with the aforementioned opposed moveable support are moveable along the axis of the pivot pins.

Preferably, biasing means are provided to bias the opposed moveable support moveable along the axis of the pivot pins against the window panel and means are also provided which are adapted to move the window panel against the bias of the biasing means.

Preferably, the displacement of the or each window panel during movement along the axis of the pivot pins is limited by a stop member.

Preferably, one or both opposed moveable supports and its associated window panel are provided with complementary engaging members.

Preferably, the means adapted to move the window panel against the bias of the biasing means include a pair of cooperating members, their arrangement being such that rotational movement of one of the cooperating members causes translational movement of the other to move the window panel against the bias of the biasing means.

Preferably, the biasing means is fitted to the frame and includes a mechanism of cooperating members, comprising a pivoting member operatively linked to a pair of translational members, their arrangement being such that movement of one translational member will cause the other translational member to move about the pivoting member to reduce the degree of bias experienced on the opposed moveable support by the bias of the biasing means. In such form, the pair of cooperating members include a rack and pinion. Also in such form, the complementary engaging members are curved. Alternatively, in such form, the complementary engaging members are flat.

Preferably, the means adapted to move the window panel against the bias of the biasing means include a pair of cooperating members, their arrangement being such that rotational movement of one of the cooperating members causes translational movement of the other to move the window panel.

Preferably, the or each window panel is able to rotate through 360 degrees.

For the avoidance of doubt, the invention is also intended to include within its scope a structure or dwelling incorporating a window as specified herein.

### BRIEF DESCRIPTION OF DRAWINGS

In order to facilitate a more detailed understanding of the nature of the invention, a preferred embodiment of the rotatable sliding window will now be described in detail, by way of example only, with reference to the accompanying drawings, in which:

FIG. 1 is a front view of an embodiment of a rotatable sliding window, the sliding movement being from side to side.

FIG. 2 is a plan view of the rotatable sliding window of FIG. 1.

FIG. 3A is a section view in side elevation of the rotatable sliding window of FIG. 1 illustrating the details of the window when the window is in a non-rotational state.

FIG. 3B is a section view in side elevation of an alternate embodiment of a rotatable sliding window similar to the embodiment shown in FIG. 1 also illustrating the details of the window when the window is in a non-rotational state.

FIG. 4 is a section view in plan elevation of the rotatable sliding window of the embodiment shown in FIG. 3A or FIG. 3B showing how both window panels of the window can be rotated through at least 180 degrees.

FIG. 5A is a section view in front elevation of one embodiment of a window panel lifting mechanism (a rack and pinion mechanism) in its lowered state.

FIG. 5B is a section view in front elevation of the embodiment of FIG. 5A in its elevated state.

FIG. 6A is a section view in side elevation of another embodiment of a window panel lifting mechanism in its lowered state.

FIG. 6B is a section view in side elevation of the embodiment of FIG. 6A in its elevated state.

FIG. 7A is an isometric view of part of a rotatable panel and an upper moveable support in the form of a top rail guide member, when the complementary engaging members of the panel and support are disengaged.

FIG. 7B is an isometric view of the rotatable window panel and the top rail guide member of FIG. 7A, when their complementary engaging members are engaged.

FIG. 8 is an isometric view of a biasing means forming part of the rotatable sliding window.

FIG. 9 is a section view in side elevation of the sliding window of FIG. 1 showing the rotatable panels rotated at an angle of 90 degrees.

FIG. 10 is an isometric view of one corner of the top rail guide member incorporating a lift-limiting device.

FIG. 11A is an isometric, wireframe view of the top rail guide member incorporating the top biasing means when the top engaging surfaces are in the engaged state.

FIG. 11B is an isometric, wireframe view of the top rail guide member incorporating the top biasing means when the top engaging surfaces are in the disengaged state.

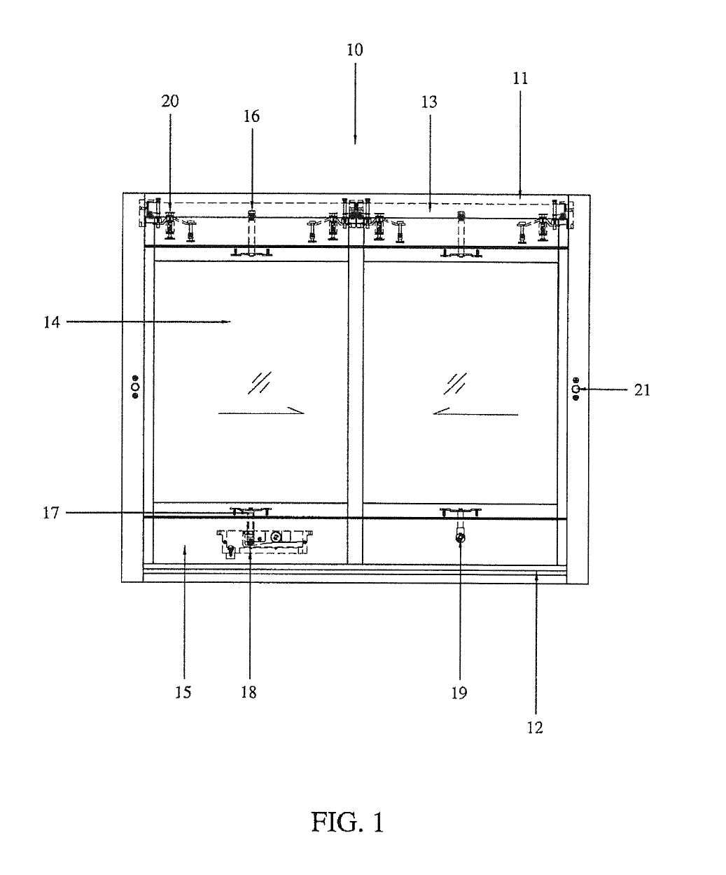

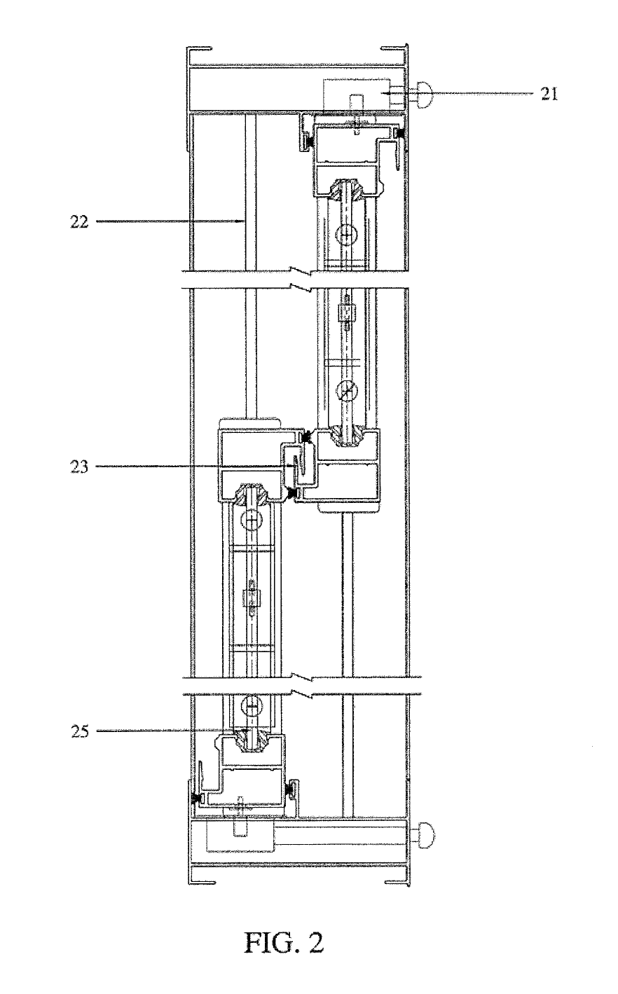

### DESCRIPTION OF THE PREFERRED EMBODIMENTS

A preferred embodiment of a rotatable sliding window 10 in accordance with the present invention is illustrated in the accompanying drawings and includes a window frame having a top horizontal frame member 11 and a bottom horizontal frame member 12. The bottom frame member 12 is provided with at least one sliding rail 22 with a contoured top sliding surface, and the top frame member 11 is provided with at least one guide track.

Each rotatable sliding window panel 14 is operatively connected to opposed moveable supports in the form of a top rail guide member 13 and a bottom rail guide member 15. The top rail guide member 13 is slidably mounted within the track of the top frame member 11. The bottom rail guide member 15 is provided with rollers 30, which are slidably mounted on the complementary contoured surface of sliding rail 22. This ensures smooth and stable sliding as well as self-alignment.

The rotatable panel 14 is mounted in-between top and bottom rail guide members 13, 15 using top and bottom pivot pins 16,17 located along a central axis of the rotatable panel 14. This pivot mounting of the rotatable panel 14 allows it to slide along the rail tracks 22 together with the top and bottom rail guide members 13, 15. This pivot mounting also allows the rotatable panel 14 to rotate 360 degrees, independent of the rail guides 13, 15, thereby allowing easy access to the outside-surface of the rotatable panel 14 for cleaning purposes.

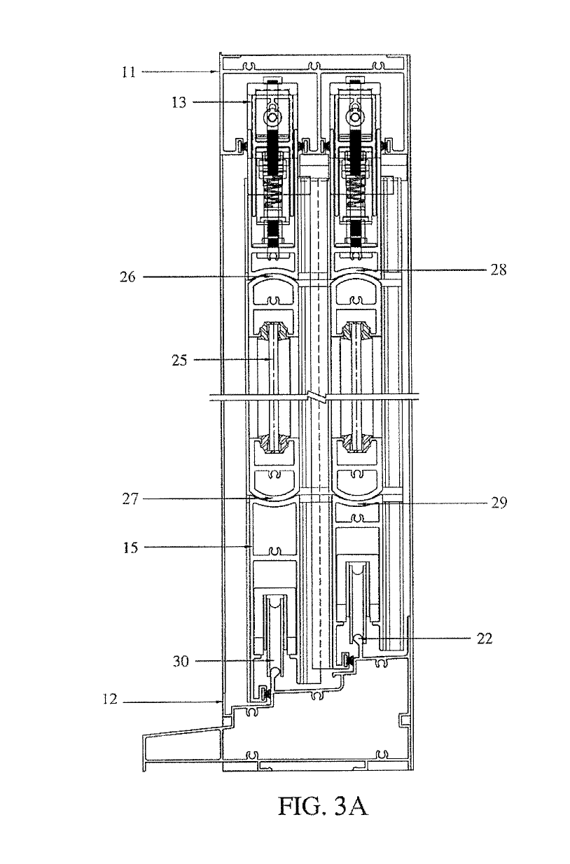

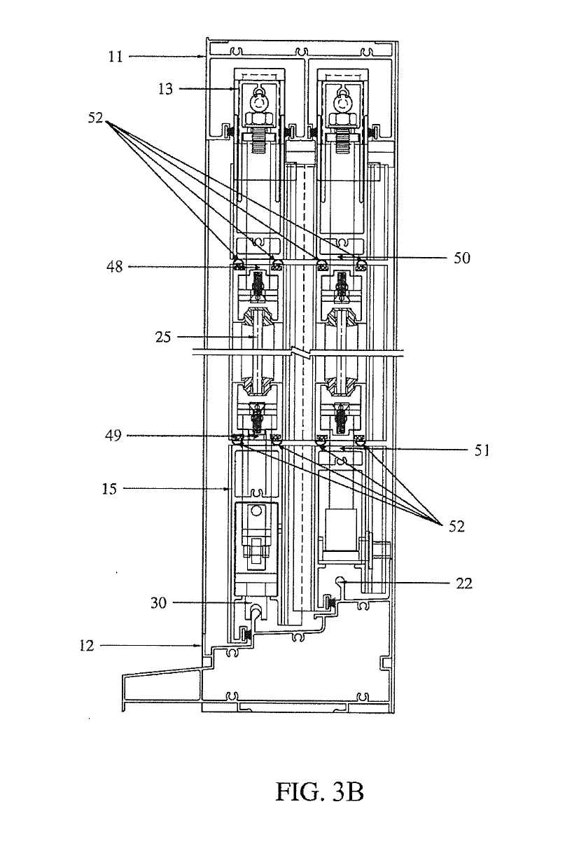

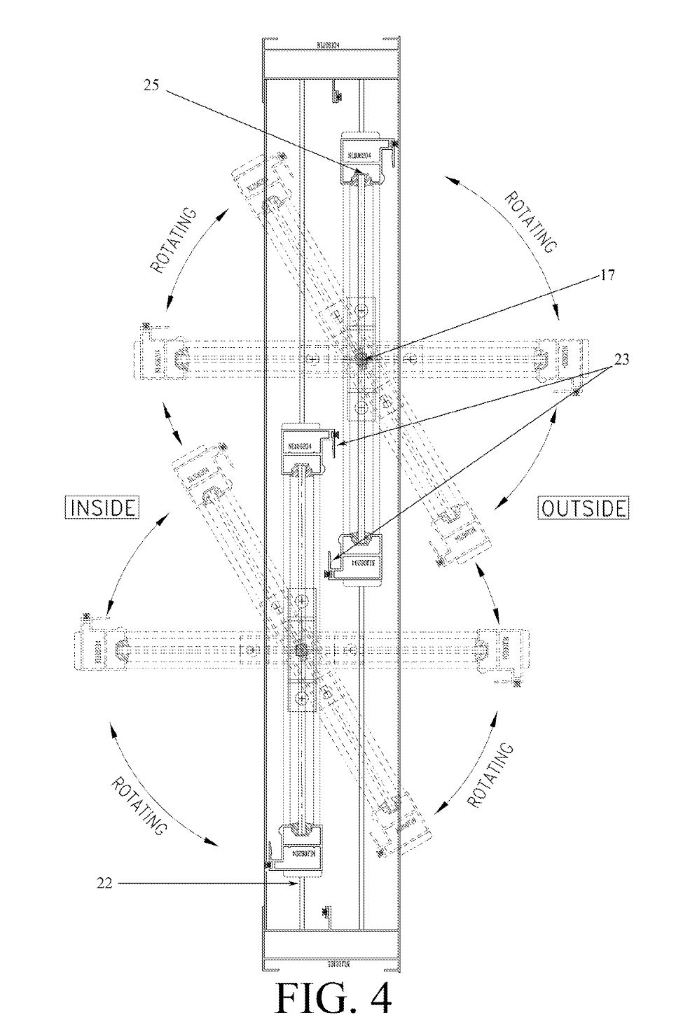

Both the top and bottom surfaces of the rotatable panel 14 are fitted with convex engaging members 26, 27. The top and bottom rail guide members 13, 15 are fitted with concave engaging members 28, 29 complementary to the convex engaging members 26,27. During sliding operation of the window, as shown in FIG. 3A, the weight of the rotatable panel 14 keeps the complementary engaging members 27, 29 engaged. The top rail guide member 13 is fitted with a top biasing mechanism 20 which keeps complementary engaging members 26, 28 engaged. The cooperation of these engaging members prevents rotation of the rotatable panel 14 while it is in sliding operation. The curved profiles of the engaging members 26, 27, 28, 29 are such that they would also restrict the passage of weather elements.

However, to further improve the seal under harsh weather conditions, the engaging members 26, 27, 28, 29 are preferably lined with a weatherproofing material. Preferably, the middle portion 25 of the rotatable panel 14 is mounted with a clear, rigid material such as glass or polycarbonate.

A lifting mechanism is provided to vertically displace the rotatable panel 14 in order to disengage the engaging members 27, 29 and allow the rotatable panel 14 to rotate. There are two preferred embodiments of this lifting mechanism, namely a translational cam in the form of a rack and pinion lifting mechanism 18, and a rotational cam lifting mechanism 19.

The translational cam lifting mechanism 18 includes a translational cam member 44 fitted with a sloping surface 31, a rack 32 which is engaged to pinion 34 and a rotation stopper 35. It also includes a cam follower shaft 33 which is restricted to allow only translation along the vertical axis and fitted with a roller bearing wheel 37 which engages with the sloping surface 31 of the translational cam. This lifting mechanism 18 is centrally fitted into the bottom rail guide 15 such that the pivot pin 17 fits into cam follower shaft 33.

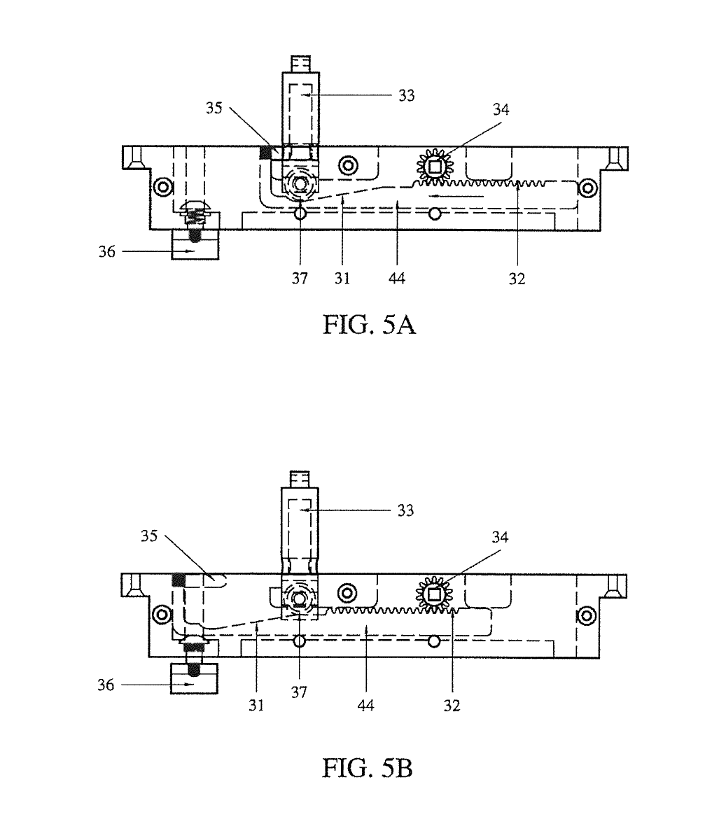

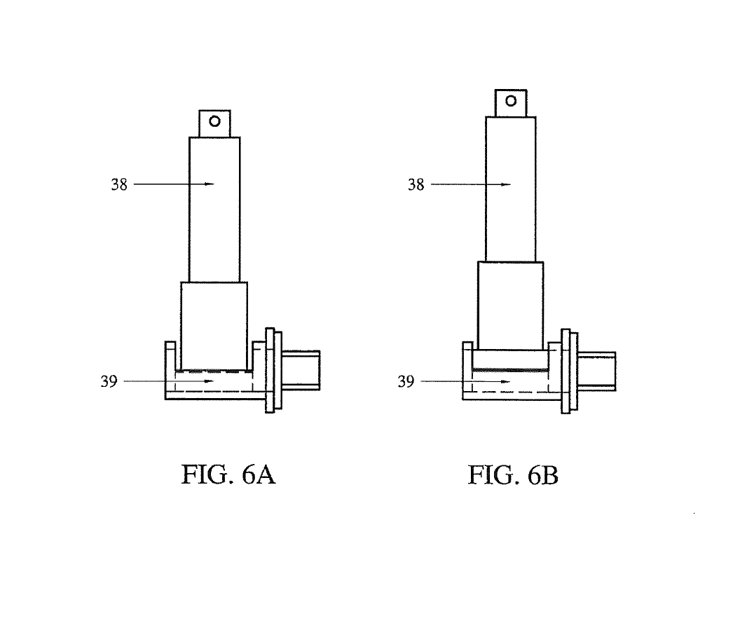

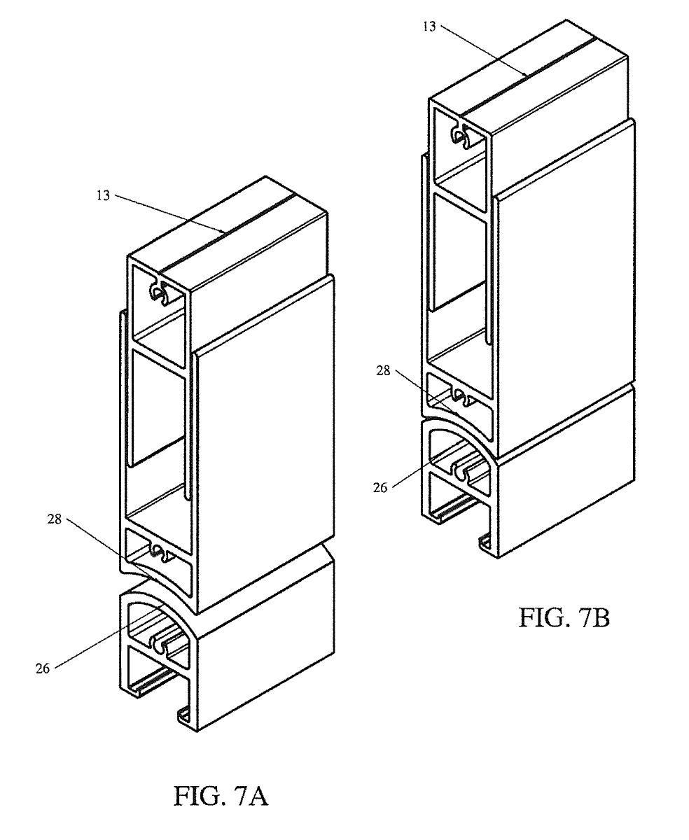

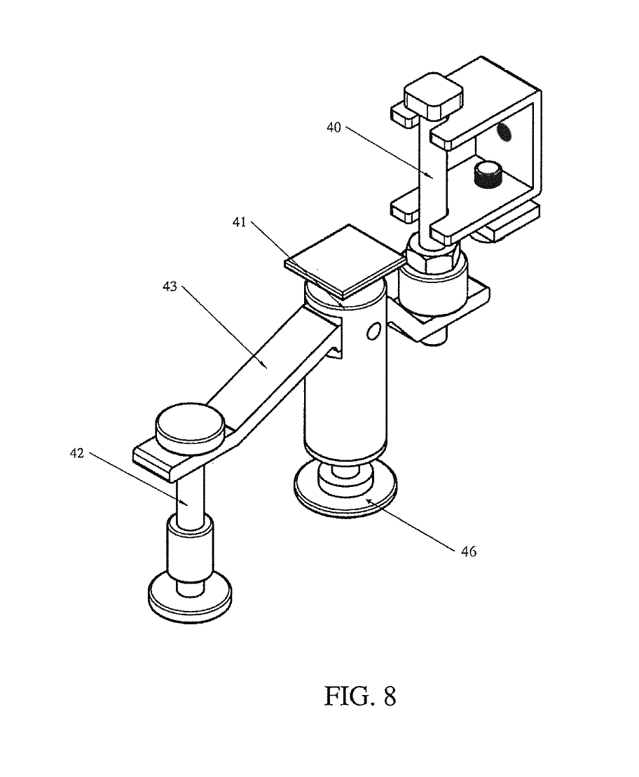

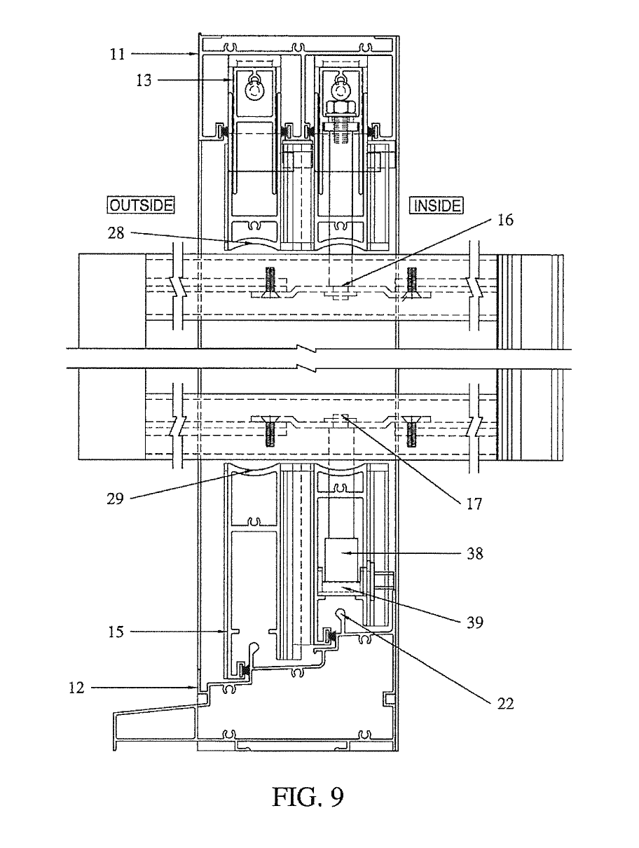

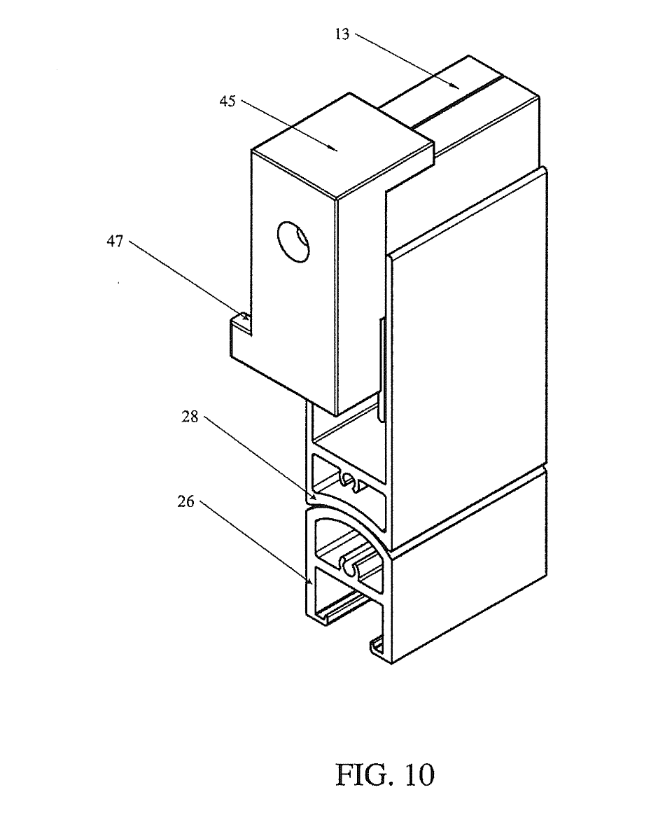

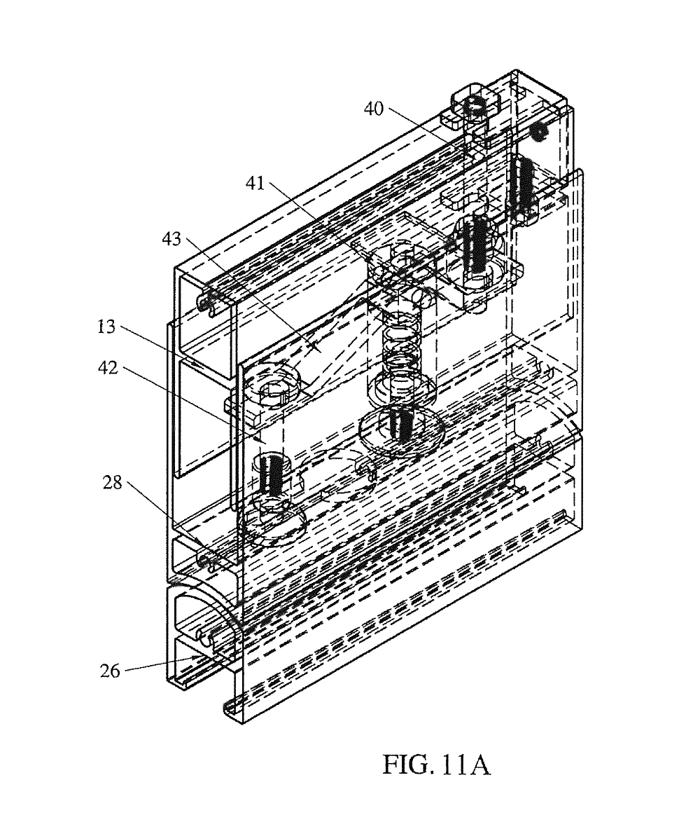

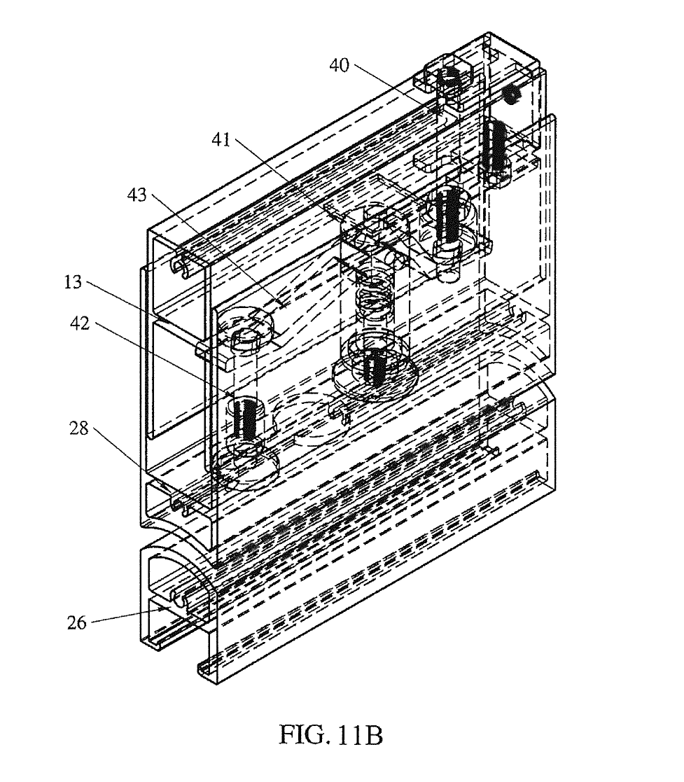

When the cam follower shaft is in its lowered state as shown FIG. 5A, the rotation stopper 35 engages with cam follower shaft 33 to prevent both the shaft 33 and the inner rotatable panel 14 from rotating. As the pinion is rotated, it actuates the rack 32 causing horizontal translation of translational cam member 44. This in turn disengages rotation stopper 35 from the cam follower shaft 33, and at the same time vertically displaces the cam follower shaft 33 together with the rotatable panel 14, thereby disengaging the engaging members 27 and 29. Preferably, when the rotation stopper 35 is disengaged from cam follower shaft 33, translational cam member 44 should also actuate a sliding stopper 36 to be lowered to engage with the bottom frame member 12 to prevent sliding of the window panel when the rotatable panel 14 is rotating.

The rotational cam lifting mechanism 19 includes a rotational cam member 39 and cam follower shaft 38, which is restricted to only allow translation along the vertical axis. This lifting mechanism 19 is centrally fitted into the bottom rail guide 15 such that the pivot pin 17 fits into cam follower shaft 38. Rotation of the rotational cam member 39 actuates the cam follower shaft between an upward and downward position.

In the upward position, the rotatable panel 14 is lifted upwards which completely disengages the engaging members 27, 29 of the bottom rail guide member 15 to allow rotation.

To allow the disengagement of the top engaging members 26, 28, member 28 is vertically moveable (but is biased into an engaged position) and its movement is facilitated by a top biasing mechanism 20.

A preferred embodiment of this top biasing mechanism 20 which is fitted to the window frame includes an effort shaft 40, a pivot shaft 41, a load shaft 42, a lever arm 43 and a spring loaded shaft 46. The lever arm 43 is pivoted in the centre region to pivot shaft 41. Effort shaft 40 and load shaft 42 are connected to opposing ends of the lever arm 43. The bottom end of both load shaft 42 and spring loaded shaft 46 are attached to engaging member 28.

During rotation of the rotational cam member 39 to raise the window panel, engaging member 28 is also raised. This causes the top of effort shaft 40 to contact the window frame and move downwards. When effort shaft 40 moves downwards, the lever arm 43 translates the downward motion into an upward motion of the load shaft 42, thereby vertically raising (and thus disengaging) engaging member 28 and compressing the spring of spring loaded shaft 46. The disengagement of engaging member 28 from the window panel reduces the degree of bias which it exerts on the window panel to zero. When vertical displacement of the window panel and load shaft 42 is complete, engaging member 28 is completely disengaged from the complementary engaging surfaces, thereby allowing rotatable panel 14 to rotate freely when rotated. When the window panel is lowered, effort shaft 40 moves upwards, lowering load shaft 42 and the compressed spring loaded shaft 46 returns member 28 to its engaged state to assist in preventing rotational motion of rotatable panel 14.

In order to improve security of the window, it has a pair of locking mechanisms 21, which are fitted onto the inside face of the lateral opposing ends of the window frame. The locking mechanisms 21 in each of their locked states will prevent the window panels from both sliding and rotating.

An additional safety feature is the lift-limiting device 45. It is attached to the top of the window panel and is designed with protruding member 47 which would engage with the edge of the top guide rail to limit the vertical displacement of the window panel to the range of motion necessary to allow for the rotating mechanism to function, thus preventing excessive displacement from dislodging the pivot member from its aperture enabling the whole window panel to be removed from its frame.

Another feature of the present embodiment is that the opposing lateral ends of the rotatable panels 14 are fitted with engaging members 23 to allow the rotatable panels to engage with one another. This would aid to improve security of the window and to also reduce the passage of weather elements. To further improve weather resistance, the edges of these engaging members 23 are lined with a weatherproofing material.

To prevent inflow of rainwater as well as retention of rainwater which might cause breeding of pests such as mosquitoes, the rail tracks 22 are fitted in a staggered manner on the bottom horizontal frame member 12, with the outer rail track lower than the inner rail track. This outward sloping profile allows for easy drainage of rainwater and prevents inflow of rainwater into the building interior.

Engaging member 29 being the lower of the engaging members in the window's normal attitude of operation is provided with a number of drainage holes at the horizontal tangent of the curved well to allow any trapped water due to rainfall which may have ingressed to escape and flow away.

An alternative embodiment of the complementary engaging members is shown in FIG. 3B. In this particular embodiment, the engaging members 48, 49, 50, 51 are flat horizontal members.

These members are lined with weatherproofing strips 52. When these engaging members are pressed together, they compress the weatherproofing strips 52 to create a waterproof seal to prevent inflow of weather elements.

The weatherproof strips when compressed would also grip the engaging members tightly to resist rotation of the window panel. Similar in operation to the embodiment using curved engaging members, this particular embodiment would also require the engaging members to move apart via similar lifting and biasing mechanisms so as to disengage the weatherproofing strips and to enable rotation of the rotatable panel.

1. A rotatable sliding window including a window frame adapted to be fixed within an opening in a structure, having one or more window panels supported within the frame between opposed moveable supports fitted to guide members in the frame, the or each window panel being adapted for slidable movement to allow the window to be opened and closed, wherein the opposed moveable supports are linked to the or each window panel via pivot pins such that:
a) the opposed moveable supports are able to slide with the or each window panel; and
b) the or each window panel is able to move relative to the opposed moveable supports and rotate about the axis of the pivot pins to move out of the sliding plane to allow access to both sides of the or each window panel;
wherein one of the opposed moveable supports associated with a window panel and the window panel associated with the aforementioned opposed moveable support are moveable along the axis of the pivot pins.

2. A window as claimed in claim 1, wherein biasing means are provided to bias the opposed moveable support moveable along the axis of the pivot pins against the window panel and means are also provided which are adapted to move the window panel against the bias of the biasing means.

3. A window as claimed in claim 1, wherein the displacement of the or each window panel during movement along the axis of the pivot pins is limited by a stop member which engages the frame.

4. A window as claimed in claim 1, wherein one or both opposed moveable supports and its associated window panel are provided with complementary engaging members.

5. A window as claimed in claim 2, wherein the means adapted to move the window panel against the bias of the biasing means include a pair of cooperating members, their arrangement being such that rotational movement of one of the cooperating members causes translational movement of the other to move the window panel against the bias of the biasing means.

6. A window as claimed in claim 2, wherein the biasing means is fitted to the frame and includes a mechanism of cooperating members, comprising a pivoting member operatively linked to a pair of translational members, their arrangement being such that movement of one translational member will cause the other translational member to move about the pivoting member to reduce the degree of bias experienced on the opposed moveable support by the bias of the biasing means.

7. A window as claimed in claim 2, wherein the means adapted to move the window panel against the bias of the biasing means include a pair of cooperating members, their arrangement being such that rotational movement of one of the cooperating members causes translational movement of the other to move the window panel.

8. A window as claimed in claim 7, wherein the pair of cooperating members include a rack and pinion.

9. A window as claimed in claim 1, wherein the or each window panel is able to rotate through 360 degrees.

10. A window as claimed in claim 3, wherein the complementary engaging members are curved.

11. A window as claimed in claim 3, wherein the complementary engaging members are flat.

12. A dwelling or structure incorporating a rotatable sliding window as claimed in claim 1.
